(19) United States
(12) Patent Application Publication
(10) Pub. No.: US 2017/0220631 A1
(43) Pub. Date: Aug. 3, 2017

(54) Capturing Intended Selection of Content Due to Dynamically Shifting Content

(71) Applicant: International Business Machines Corporation, Armonk, NY (US)

(72) Inventors: Ilse M. Breedvelt-Schouten, Manotick (CA); Ryan K. Cradick, Oronoco, MN (US)

(21) Appl. No.: 15/488,788

(22) Filed: Apr. 17, 2017

Related U.S. Application Data
(63) Continuation of application No. 15/004,225, filed on Jan. 22, 2016.

(51) Int. Cl. G06F 17/30

(52) U.S. Cl. CPC G06F 17/30377; G06F 17/30699; G06F 17/30002; G06F 17/30648; G06F 17/30663; G06F 17/30716; G06F 17/30383

(57) ABSTRACT

A mechanism is provided to implement an action for an intended selection of content element due to dynamically shifting content. For a set of content elements displayed in a user interface, changes to locations of the set of content elements and a set of user interactions with the set of content elements are analyzed. A determination is made as to whether a loading of a dynamic content element will cause a user's intended selection of the content element within the set of content elements to be erroneously performed. Responsive to determining that the loading of the dynamic content element will cause the user's intended selection of the content element to be erroneously performed, the action for the intended selection of the content element that takes into account the loading of the dynamic content element is implemented.

### BACKGROUND

The present application relates generally to an improved data processing apparatus and method and more specifically to mechanisms for capturing an intended selection of content due to dynamically shifting content.

A server-side dynamic web page is a web page whose construction is controlled by an application server processing server-side scripts. In server-side scripting, parameters determine how the assembly of every new web page proceeds, including the setting up of more client-side processing. A client-side dynamic web page processes the web page using HyperText Markup Language (HTML) scripting running in the browser as it loads. JavaScript and other scripting languages determine the way the HTML in the received page is parsed into the Document Object Model (DOM), that represents the loaded web page. The same client-side techniques can then dynamically update or change the DOM in the same way. A dynamic web page is then reloaded by the user or by a computer program to change some variable content, i.e. dynamic content that changes frequently and engages the reader, such as animations, video, audio, or the like. The dynamic content may come from the server or from changes made to that page's DOM. This may or may not truncate the browsing history or create a saved version to go back to.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided to implement an action for an intended selection of content element due to dynamically shifting content. The illustrative embodiment analyzes, for a set of content elements displayed in a user interface, changes to locations of the set of content elements and a set of user interactions with the set of content elements. The illustrative embodiment determines whether a loading of a dynamic content element will cause a user's intended selection of the content element within the set of content elements to be erroneously performed. The illustrative embodiment implements the action for the intended selection of the content element that takes into account the loading of the dynamic content element in response to determining that the loading of the dynamic content element will cause the user's intended selection of the content element to be erroneously performed.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 depicts a block diagram of a browser program in which aspects of the illustrative embodiments may be implemented;

FIG. 4 depicts an exemplary functional block diagram of a content selection mechanism in accordance with an illustrative embodiment;

FIG. 5 depicts a high-level illustration of the operations performed by a content selection mechanism in accordance with an illustrative embodiment;

FIG. 6 depicts a high-level illustration of the operations performed by a content selection mechanism in accordance with an illustrative embodiment; and

FIG. 7 depicts a flowchart of the operation performed by a content selection mechanism in accordance with an illustrative embodiment.

### DETAILED DESCRIPTION

As stated previously, many web pages as well as other graphical user interfaces, such as news sites, social sites, or the like, comprise dynamic content. The dynamic content in these user interfaces may shift up, down, left, or right as new information is available. The shifting of the dynamic content may lead to interesting side effects, such as a user selecting, via a mouse click, items that the user did not intend to select, because the dynamic content suddenly shifted under their pointer either itself or as the result of other dynamic content. For example, many websites now have advertisements that load at the top of the page, causing other static content or dynamic content to shift down in the web page. If the user attempts to select the content just before the advertisement loads or as the advertisement loads, then the user may select something other than which the user intended.

Therefore, the illustrative embodiments provide mechanisms for providing a user, who is interacting with a graphical user interface comprising dynamic content, to select intended content in a manner that accounts for changes by the dynamic content. The mechanisms of the illustrative embodiments predict and execute user interactions with a graphical user interface comprising dynamic content by tracking both static content and dynamic content within the user interface over a period of time. More specifically, the mechanisms track changes in the dynamic content over the time period as well as changes to the static content caused by the dynamic content. Additionally, the mechanisms track the user's interactions with the user interface over a period of time so as to determine what content the user is attempting to interact with by analyzing the locations of the static content, the dynamic content, and the user interaction(s) with the user interface over the period of time. Utilizing the predicted behavior of the user and the content within the user interface, the mechanisms execute one or more actions that account for the changing dynamic content when the user interacts with the user interface. For example, in an event where an advertisement (dynamic content) is about to load at the top of a page, the mechanisms determine a location of the user's mouse with regard to other content on the page and a location of the other content prior to any movement caused by the advertisement. If, prior to the user selecting the content by clicking the mouse, the intended content shifts due to the displaying of the advertisement, the mechanisms execute the click of the mouse on a correct location for which the user intended.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

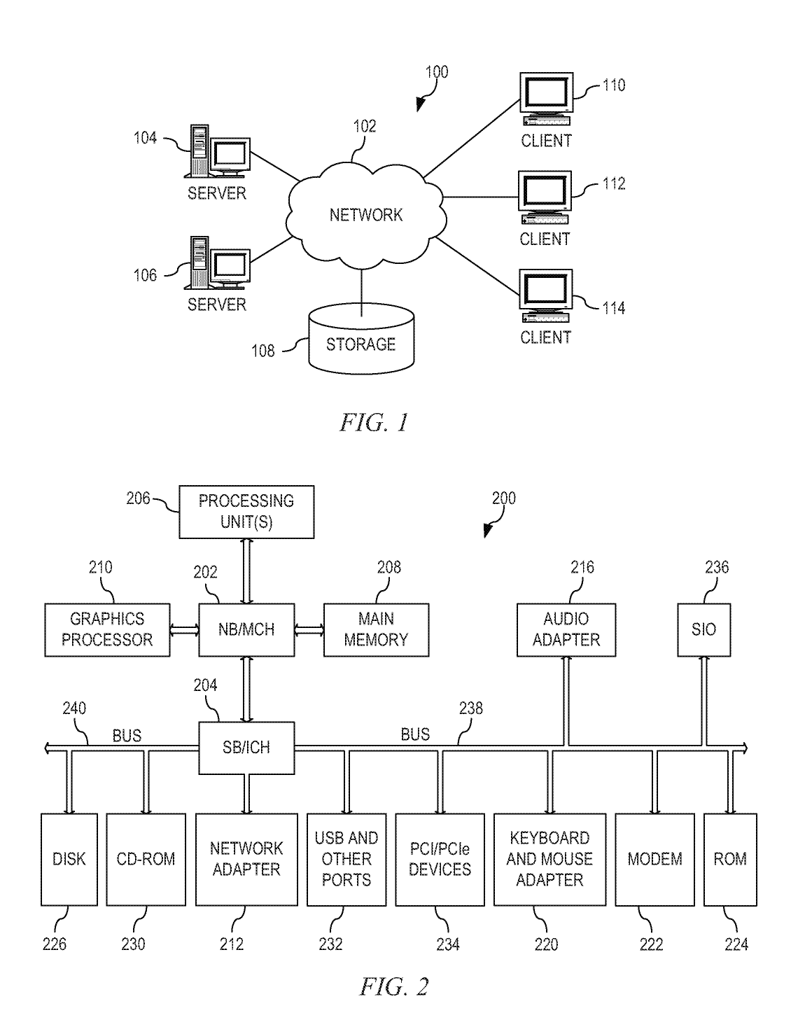

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104, may be specifically configured to implement a mechanism for capturing an intended selection of content due to dynamically shifting content in a user interface. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates capturing an intended selection of content due to dynamically shifting content in a user interface.

As noted above, the mechanisms of the illustrative embodiments utilize specifically configured computing devices, or data processing systems, to perform the operations for capturing an intended selection of content due to dynamically shifting content in a user interface. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to the capturing an intended selection of content due to dynamically shifting content in a user interface.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

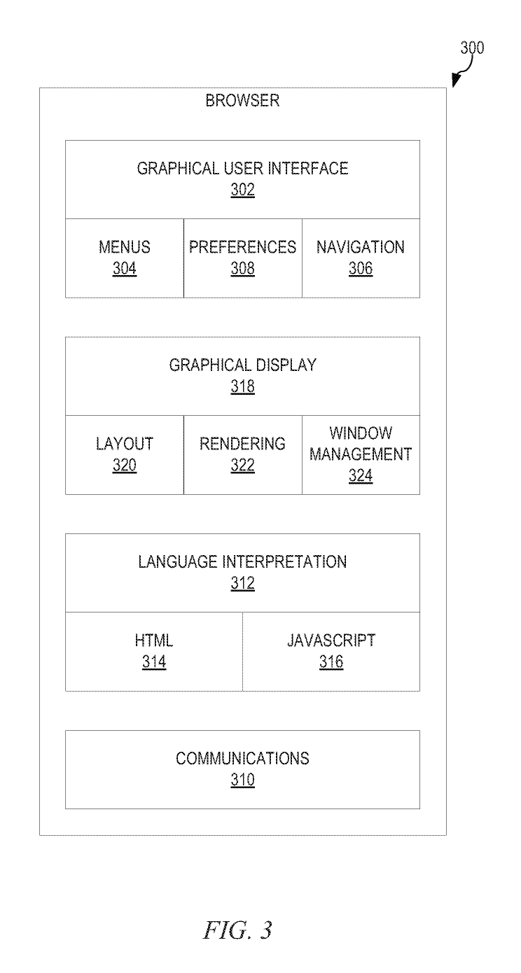

Turning next to FIG. 3, a block diagram of a browser program is depicted in which aspects of the illustrative embodiments may be implemented. Browser 300 is provided as one example of an application executed by a data processing, such as data processing system 200 of FIG. 2, used to navigate or view information or data in a distributed database, hereinafter referred to as content, such as the Internet or the World Wide Web.

In this example, browser 300 includes a user interface 302, which is a graphical user interface (GUI) that allows the user to interface or communicate with browser 300. This interface provides for selection of various functions through menus 304 and allows for navigation through navigation 306. For example, menu 304 may allow a user to perform various functions, such as saving a file, opening a new window, displaying a history, and entering a Uniform Resource Identifier (URI). Navigation 306 allows for a user to navigate various pages and to select web sites for viewing. For example, navigation 306 may allow a user to see a previous page or a subsequent page relative to the present page. Preferences such as those illustrated in FIG. 3 may be set through preferences 308.

Communications 310 is the mechanism with which browser 300 receives documents and other resources from a network such as the Internet. Further, communications 310 is used to send or upload documents and resources onto a network. In the depicted example, communications 310 uses Hypertext Transfer Protocol (HTTP). Other protocols may be used depending on the implementation. Documents that are received by browser 300 are processed by language interpretation 312, which includes a HyperText Markup Language (HTML) unit 314 and a JavaScript™ unit 316. Language interpretation 312 will process a document for presentation on graphical display 318. In particular, HTML statements are processed by HTML unit 314 for presentation while JavaScript statements are processed by JavaScript™ unit 316.

Graphical display 318 includes layout unit 320, rendering unit 322, and window management 324. These units are involved in presenting web pages to a user based on results from language interpretation 312.

Browser 300 is presented as an example of a browser program in which the present invention may be embodied. Browser 300 is not meant to imply architectural limitations to the present invention. Presently available browsers may include additional functions not shown or may omit functions shown in browser 300. A browser may be any application that is used to search for and display content on a distributed data processing system. Browser 300 may be implemented using known browser applications.

Again, browser 300 is provided as one example of an application that provides a user interface with which a user can view content. The illustrative embodiments recognize that there are many other type of applications that provide a user interface to display content and, thus, the illustrative embodiments are not limited to only browser type applications.

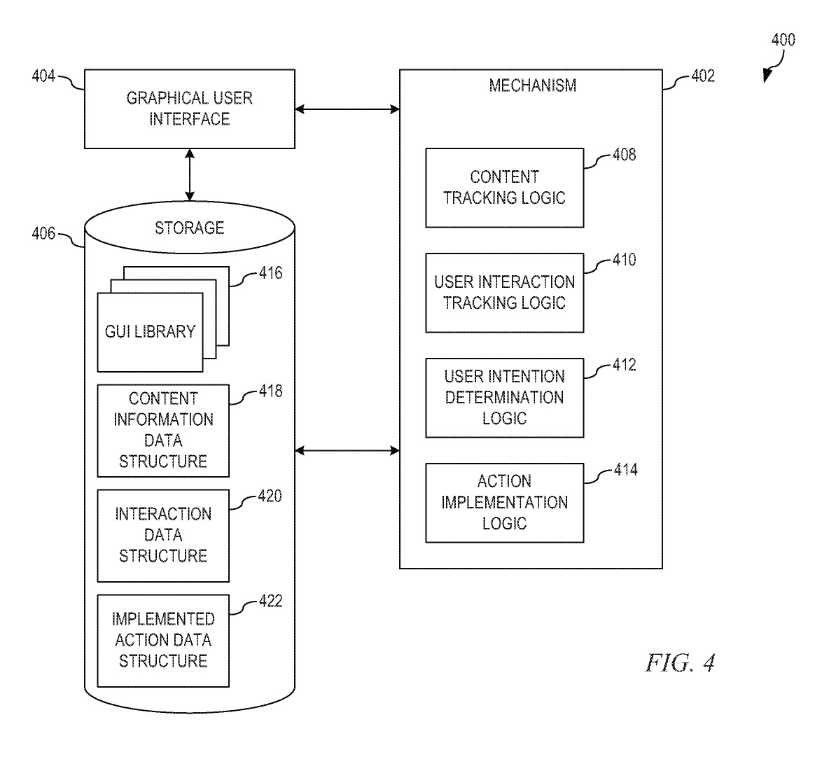

FIG. 4 depicts an exemplary functional block diagram of a content selection mechanism in accordance with an illustrative embodiment. Data processing system 400, which is a data processing such as data processing system 200 of FIG. 2, comprises content selection mechanism 402, graphical user interface (GUI) 404, and storage 406. Content selection mechanism 402 further comprises content tracking logic 408, user interaction tracking logic 410, user intention determination logic 412, and action implementation logic 414. In operation, content tracking logic 408 utilizes existing GUI libraries 416 to track location (x and y coordinates within the page being displayed), width, height, or the like, of each of a plurality of content elements within the page as they are loaded, changed, moved, or the like. Content tracking logic 408 tracking the location of each of the plurality of content elements in this manner allows for each content element to be mapped directly to a space on the display with respect to a specific time. Therefore, for each of a plurality of time intervals where a content element is displayed on a display, content tracking logic 408 identifies a location, width, length, or the like, of the content element and stores the information associated with each content element in content information data structure 418 in storage 406. Again, each content element may be a static content element or a dynamic content element. A static content element is a content element that has a defined width and height that does not change even though the location of the content element may change due to changes in other content elements. A dynamic content element is a content element that may change in height and/or width as well as having its location change due to the dynamic nature of the element and/or changes in other content elements.

For example, for a static content element, content tracking logic 408 may store:

| | ‘x’ | | | | | |
|---|---|---|---|---|---|---|
| Element | loca- | ‘y’ | | | | |
| ID: | tion | location | Width | Height | Date | Time |
| Story-311 | 30 | 100 | 500 | 40 | May 1, 2015 | 02:19:39 |
| Story-311 | 30 | 150 | 500 | 40 | May 1, 2015 | 02:19:49 |
| Story-311 | 30 | 100 | 500 | 40 | May 1, 2015 | 02:24:49 |

Thus, the ‘Story-311’ element is tracked as a static content element that has the same width and height for each of the tracked time intervals but changes location within a brief time period (i.e., milliseconds, seconds, or the like) after loading and then returns to the original location five minutes after the change.

As another example, for a dynamic content element, content tracking logic 408 may store:

| | ‘x’ | | | | | |
|---|---|---|---|---|---|---|
| Element | loca- | ‘y’ | | | | |
| ID: | tion | location | Width | Height | Date | Time |
| Story-513 | 30 | 80 | 800 | 80 | May 1, 2015 | 02:19:49 |
| Story-513 | 30 | 80 | 800 | 15 | May 1, 2015 | 02:29:49 |

Thus, the ‘Story-513’ element is tracked as a dynamic content element that has the different height for five minutes and then changes to a smaller content.

User interaction tracking logic 410 performs a similar operation to that of content tracking logic 408 but for a user's interactions with the displayed page. That is, based on user interactions with the displayed page, user interaction tracking logic 410 identifies locations where, via a mouse movement, the user's mouse is accelerating to, decelerating to, or hovering over; identifies locations where, via a mouse click, the user's mouse selected a particular content element; identifies location where, via a webcam, the users eye focus is with regard to a particular content element; or the like. User interaction tracking logic 410 stores the interaction information in interaction data structure 420 in storage 406.

For example, user interaction tracking logic 410 for a particular page may store:

| Interaction type | ‘x’ location | ‘y’ location | Date | Time |
|---|---|---|---|---|
| Eye focus | 40 | 120 | 05/01/15 | 02:19:39 |
| Mouse | 40 | 122 | 05/01/15 | 02:19:48 |
| movement | | | | |
| Mouse click | 40 | 122 | 05/01/15 | 02:19:50 |
| Eye focus | 40 | 160 | 05/01/15 | 02:20:32 |
| Mouse | 40 | 163 | 05/01/15 | 02:20:38 |
| movement | | | | |
| Mouse click | 40 | 163 | 05/01/15 | 02:20:40 |

Thus, with relation to the content information in content information data structure 418 illustrated above, user interaction tracking logic 410 tracks that the user intended to select the ‘Story-311’ static content element as the user eye focus was trained on the ‘Story-311’ static content element. However, when the user clicked the mouse, the ‘Story-311’ static content element had moved locations due to the ‘Story-513’ dynamic content element. Thus, the first mouse click was on the ‘Story-513’ dynamic content element. The user then changed eye focus lower on the page where the ‘Story-311’ static content element was moved due to the ‘Story-513’ dynamic content element and clicked the mouse on the location of the ‘Story-311’ static content element.

Knowing the locations and changes in content elements stored in content information data structure 418 as well as how the user is interacting with the user interface over a plurality of time intervals stored in interaction data structure 420, user intention determination logic 412 is able to account for the loading of dynamic content, such as the ‘Story-513’ dynamic content element. That is, in the example, the static content existed at the location that the user intended to select only a brief time period (i.e., milliseconds, seconds, or the like) before the user actually clicked the mouse but the static content was moved by dynamic content. Thus, user intention determination logic 412 compares the data in the content information data structure 418 with the data in interaction data structure 420 to identify when dynamic content that is loading will cause a user's intended action to be erroneously performed, i.e. selecting a wrong content element.

Continuing with the example above, a time 02:19:39 the user's eye focus corresponded with the ‘Story-311’ static content element and at time 02:19:48 the user's mouse movement also corresponded with the ‘Story-311’ static content element. However, before the user's mouse click at time 02:19:50, the ‘Story-513’ dynamic content element loaded at the location where the mouse click was performed. User intention determination logic 412 monitors the eye focus and the mouse movement and, if dynamic content causes the intended content to move prior to the mouse click, user intention determination logic 412 determines that the user actually intended to select the ‘Story-311’ static content element that was moved and not the ‘Story-513’ dynamic content element that has since taken the content's place.

In the event that user intention determination logic 412 determines that the user's eye focus and/or mouse movement is associated with a particular content element and that particular content element changes or moves prior to the user clicking the mouse, user intention determination logic 412 sends a notification to action implementation logic 414 so that the change or movement due to the loading of any dynamic content may be accounted for. If action implementation logic 414 receives such a notification from user intention determination logic 412, action implementation logic 414 may then implement a specific action to account for the user's intentions. User intention determination logic 412 and/or action implementation logic 414 store the notification and implemented action in implemented action data structure 422.

In one embodiment, action implementation logic 414 may create a virtual content element for the intended content element that overlaps the dynamic content element that is loading so that any interaction intended for the content element is performed with the virtual content element. The virtual content element is only a temporary content element and may only exist for a small predetermined time period and then be removed. That is, if the user notices the loading of the dynamic content and changes eye focus and moves the mouse, then the virtual content element is no longer needed.

In another embodiment, action implementation logic 414 may translate any mouse click performed by the user to the new location where the intended content element moved due to the loading of the dynamic content. For example, continuing with the example above, if the user's intended mouse click ‘x’ location 40, ‘y’ location 122 at time 02:19:50 was for a content element that was in that location only a brief time period (i.e., milliseconds, seconds, or the like) before, then action implementation logic 414 may translate the mouse click down to ‘x’ location 40, ‘y’ location 163 so that the correct content is selected by the mouse click.

While the above example is directed to user intention determination logic 412 comparing data in the content information data structure 418 and the interaction data structure 420, user intention determination logic 412 may also verify whether previous intentions identified by user intention determination logic 412 and implemented by action implementation logic 414 were the actual intention of the user. That is, after user intention determination logic 412 makes a determination that the user's eye focus and/or mouse movement is associated with a particular content element and that particular content element changes or moves prior to the user clicking the mouse but prior to sending a notification to action implementation logic 414 so that the change or movement due to the loading of any dynamic content may be accounted for, user intention determination logic 412 may check whether a preceding predetermined number of the implemented action identified in implemented action data structure 422 were immediately undone by the user thereby indicating that the user actually intended to select the content where the mouse click was performed.

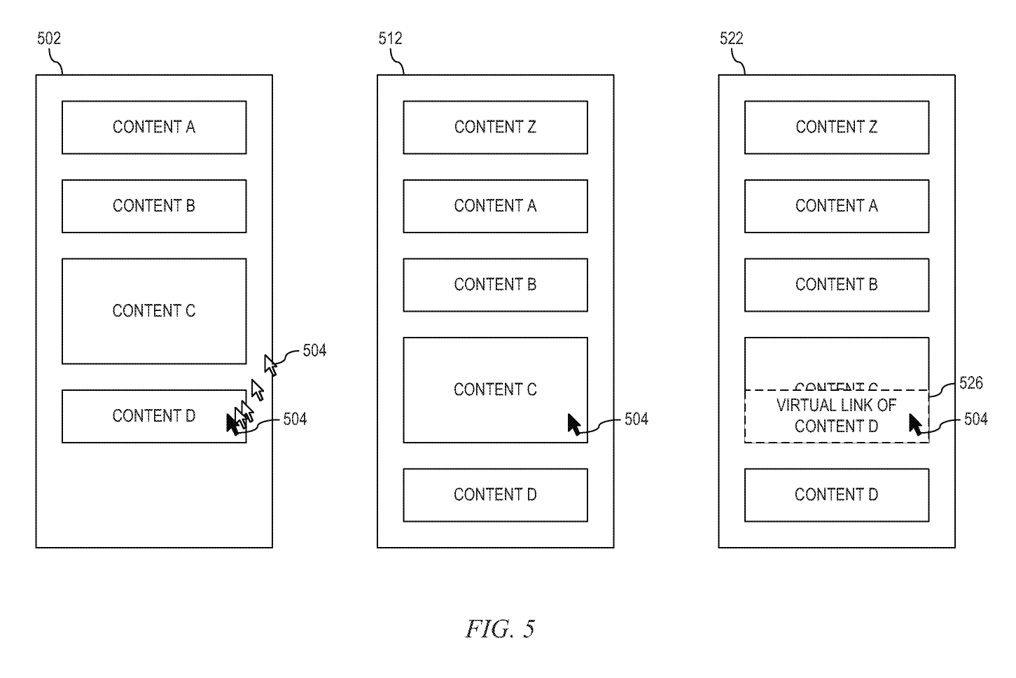

FIG. 5 depicts a high-level illustration of the operations performed by a content selection mechanism, such as content selection mechanism 402 of FIG. 4, in accordance with an illustrative embodiment. As is illustrated in page 502, the content selection mechanism identifies the user's intended target by identifying the deceleration and final location of the mouse pointer 504. That is, the content selection mechanism determined the intended content because the last few mouse pointer locations showed a movement to content element D and a last resting point of content element D. As is illustrated in page 512, just before the user clicks the mouse pointer, content element D as well as content elements A-C are moved down due to loading of content element Z. In accordance with the illustrative embodiment, the content selection mechanism compares the pages old content to the new content. Based on this comparison and the fact that mouse pointer 504 has not moved since the new content element Z loaded, the content selection mechanism determines that any subsequent mouse click in the next brief time period (i.e., a few milliseconds, a few seconds, or the like) would be directed to content element D and not content element C that the mouse is currently pointer to. Thus, in anticipation of an interaction with content element D, as is illustrated in page 522, the content selection mechanism creates a virtual link to content element D 526 that overlaps content element C for a predetermined time period so that any mouse click at the location indicated by mouse pointer 504 in the next brief time period (i.e., few milliseconds, few seconds, or the like) would correctly select content element D and not an erroneous selection of content element C.

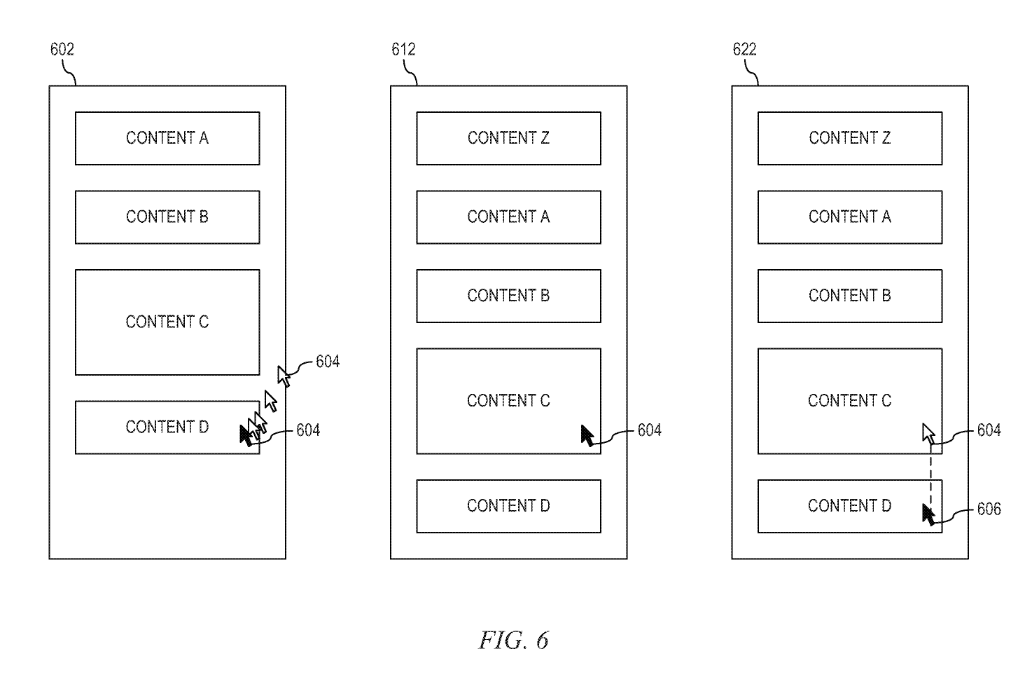

FIG. 6 depicts a high-level illustration of the operations performed by a content selection mechanism, such as content selection mechanism 402 of FIG. 4, in accordance with an illustrative embodiment. As is illustrated in page 602, the content selection mechanism identifies the user's intended target by identifying the deceleration and final location of the mouse pointer 604. That is, the content selection mechanism determined the intended content because the last few mouse pointer locations showed a movement to content element D and a last resting point of content element D. As is illustrated in page 612, just before the user clicks the mouse pointer, content element D as well as content elements A-C are moved down due to loading of content element Z. In accordance with the illustrative embodiment, the content selection mechanism compares the pages old content to the new content. Based on this comparison and the fact that mouse pointer 604 has not moved since the new content element Z loaded, the content selection mechanism determines that any subsequent mouse click in the next brief time period (i.e., few milliseconds, few seconds, or the like) would be directed to content element D and not content element C that the mouse is currently pointer to. Thus, in anticipation of an interaction with content element D, as is illustrated in page 622, the content selection mechanism translates the position of mouse pointer 604 down to content element D as translated mouse pointer 606 so that any mouse click at the location indicated by mouse pointer 604 in the next brief time period (i.e., few milliseconds, few seconds, or the like) would translate to the location of translated mouse pointer 606 and correctly select content element D and not an erroneous selection of content element C.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

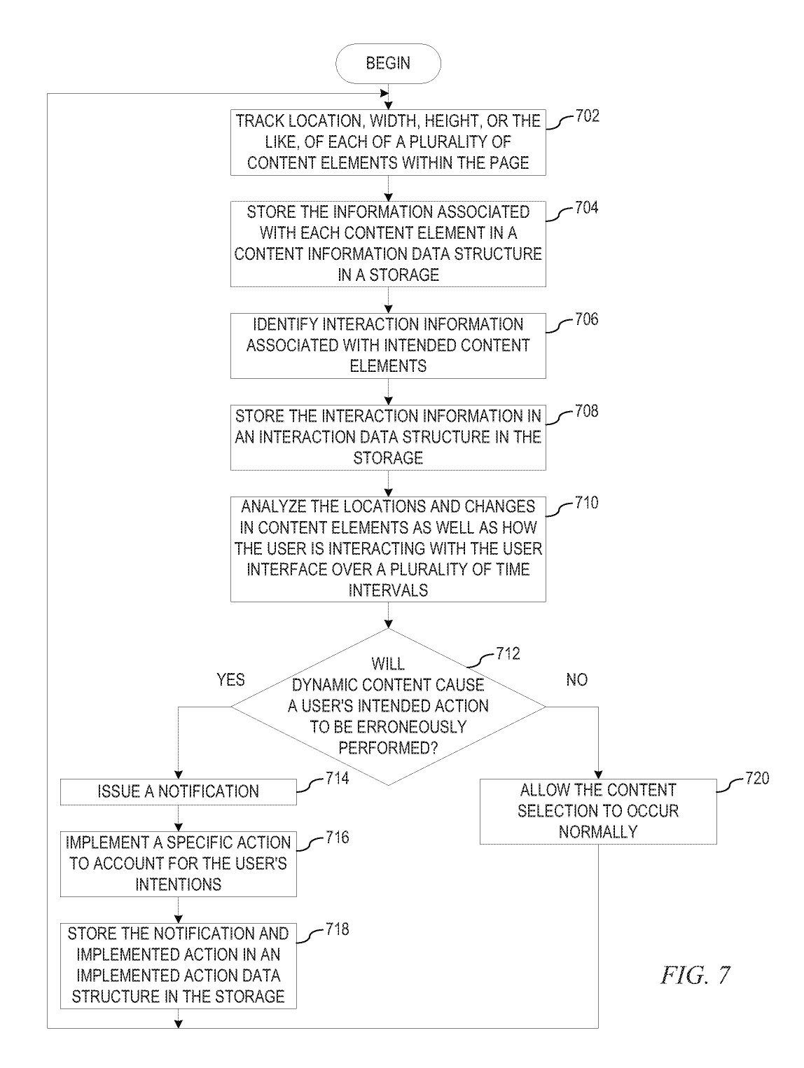

FIG. 7 depicts a flowchart of the operation performed by a content selection mechanism, such as content selection mechanism 402 of FIG. 4, in accordance with an illustrative embodiment. As the operation begins, the content selection mechanism utilizes existing GUI libraries to track location (x and y coordinates within the page being displayed), width, height, or the like, of each of a plurality of content elements within the page as they are loaded, changed, moved, or the like (step 702). The content selection mechanism tracking the location of each of the plurality of content elements in this manner allows for each content element to be mapped directly to a space on the display with respect to a specific time. Therefore, for each of a plurality of time intervals where a content element is displayed on a display, the content selection mechanism identifies a location, width, length, or the like, of the content element and stores the information associated with each content element in a content information data structure in a storage (step 704).

The content selection mechanism also identifies interaction information associated with intended content elements (step 706) such as locations where, via a mouse movement, the user's mouse is accelerating to, decelerating to, or hovering over identifies locations where, via a mouse click, the user's mouse selected a particular content element; identifies location where, via a webcam, the user's eye focus is with regard to a particular content element; or the like. The content selection mechanism stores the interaction information in an interaction data structure in the storage (step 708).

The content selection mechanism then analyzes the locations and changes in content elements stored in the content information data structure as well as how the user is interacting with the user interface over a plurality of time intervals stored (step 710) in the interaction data structure in order to account for the loading of dynamic content. Based on the analysis, the content selection mechanism determines whether any dynamic content that is loading will cause a user's intended action to be erroneously performed (step 712). If at step 712 the content selection mechanism determines that the user's eye focus and/or mouse movement is associated with a particular content element and that particular content element changes or moves prior to the user clicking the mouse, the content selection mechanism issues a notification (step 714) and implements a specific action to account for the user's intentions (step 716). The content selection mechanism then stores the notification and implemented action in an implemented action data structure in the storage (step 718), with the operation returning to step 702 thereafter. If at step 712 the content selection mechanism determines that the user's eye focus and/or mouse movement is associated with a particular content element and that particular content element does not change or move prior to the user clicking the mouse, then the content selection mechanism allows the content selection to occur normally (step 720), with the operation returning to step 702 thereafter.

In one embodiment, the content selection mechanism may create a virtual content element for the intended content element that overlaps the dynamic content element that is loading so that any interaction intended for the content element is performed with the virtual content element. The virtual content element is only a temporary content element and may only exist for a predetermined time period and then be removed. That is, if the user notices the loading of the dynamic content and changes eye focus and moves the mouse, then the virtual content element is no longer needed. In another embodiment, the content selection mechanism may translate any mouse click performed by the user to the new location where the intended content element moved due to the loading of the dynamic content.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for selecting intended content in a manner in that accounts for changes by the dynamic content for a user who is interacting with a graphical user interface comprising dynamic content. The mechanisms of the illustrative embodiments predict and execute user interactions with a graphical user interface comprising dynamic content by tracking both static content and dynamic content within the user interface over a period of time. More specifically, the mechanisms track changes in the dynamic content over the time period as well as changes to the static content caused by the dynamic content. Additionally, the mechanisms track the user's interactions with the user interface over a period of time so as to determine what content the user is attempting to interact with by analyzing the locations of the static content, the dynamic content, and the user interaction(s) with the user interface over the period of time. Utilizing the predicted behavior of the user and the content within the user interface, the mechanisms execute one or more actions that account for the changing dynamic content when the user interacts with the user interface.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method, in a data processing system comprising a processor and a memory having instructions which, when executed by the processor, cause the processor to implement an action for an intended selection of content element due to dynamically shifting content, the method comprising:
analyzing, for a set of content elements displayed in a user interface, changes to locations of the set of content elements and a set of user interactions with the set of content elements;
determining whether a loading of a dynamic content element will cause a user's intended selection of the content element within the set of content elements to be erroneously performed; and
responsive to determining that the loading of the dynamic content element will cause the user's intended selection of the content element to be erroneously performed, implementing the action for the intended selection of the content element that takes into account the loading of the dynamic content element.

2. The method of claim 1, wherein the user's intended selection is identified based on one or more of an eye focus of the user on the user interface, a movement of a mouse within the user interface, or a location of the mouse within the user's interface.

3. The method of claim 1, wherein the action for the intended selection of the content element that takes into account the loading of the dynamic content element is implementing a virtual content element corresponding to the content element that is the intended selection of the user and wherein the virtual content element is at a location of the content element prior to the loading of the dynamic content element.

4. The method of claim 1, wherein the action for the intended selection of the content element that takes into account the loading of the dynamic content element is implementing a translation of the location of a mouse pointer prior to the loading of the dynamic content element to a current location corresponding to the content element that is the intended selection of the user.

5. The method of claim 1, wherein the locations of the set of content elements is identified by the method comprising:
for each content element in the set of content elements, tracking a location, width, and height, for the content element for a plurality of time intervals in order to map the area of the user interface that the content element occupies during each of the plurality of time intervals; and
storing the location, width, and height, for the content element in a content information data structure in a storage.

6. The method of claim 1, wherein the set of user interactions with the set of content elements is identified by the method comprising:
for each user interaction in the set of user interactions, tracking a set of locations where the user is focusing within the user interface and wherein the set of locations is at least one of a mouse movement indicating accelerating to, decelerating to, or hovering over a particular content element; a mouse click of a particular content element; or an eye focus to a particular content element within the user interface; and
storing the user interaction in an interaction data structure in a storage.

7. The method of claim 1, wherein each content element in the set of content elements is one of a static content element or a dynamic content element, wherein the static content element is a content element that has a defined width and height that does not change even though the location of the content element may change due to changes in other content elements in the set of content elements, and wherein the dynamic content element is a content element that may change in at least one of height or width as well as having its location change due to at least one of a dynamic nature of the dynamic content element or changes in other content elements in the set of content elements.

8-20. (canceled)
